(19) United States
(12) Patent Application Publication
(10) Pub. No.: US 2006/0285052 A1
(43) Pub. Date: Dec. 21, 2006

(54) Liquid crystal display

(76) Inventors: Cheol-Soo Jung, Cheonan-city (KR); Keon-Kook Han, Ansan-city (KR); Young-Kuil Joo, Cheonan-city (KR); Ji-Yong Ko, Cheonan-city (KR); Young-Hwan Cho, Cheonan-city (KR); Kyoung-Woo Min, Seoul (KR)

Correspondence Address: F. CHAU & ASSOCIATES, LLC, 130 WOODBURY ROAD, WOODBURY, NY, 11797, US

(21) Appl. No.: 11/446,457

(22) Filed: Jun. 2, 2006

Related U.S. Application Data
(63) Continuation-in-part of application No. 11/180,654, filed on Jul. 14, 2005.
Application No. 11/180,654 is a continuation of application No. 10/398,480, filed on May 22, 2003, now Pat. No. 6,927,827.

(30) Foreign Application Priority Data
Aug. 7, 2001 (KR) 10-2001-0047488
Aug. 6, 2002 (WO) PCT/KR02/01494

(51) Int. Cl. G02F 1/1343

(52) U.S. Cl. 349/148

(57) ABSTRACT

The present invention relates to a liquid crystal display. The relation of ε (permittivity)·ρ (resistivity) between a liquid crystal layer, an aligning layer or an overcoat for preventing poor images is established. An LCD according to the present invention includes a first panel including a plurality of devices thereon and an aligning layer formed on the entire surface thereof, a second panel opposite to the first panel and including an overcoat and an aligning layer sequentially formed on the entire surface thereof, and a liquid crystal layer interposed between the first panel and the second panel. It is preferable that the aligning layer, the liquid crystal layer and the overcoat satisfy the relation

$$\frac{{ρɛ}_{lc + al}}{{ρɛ}_{oc}} ≻ {10}^{2} .$$

An LCD according to another embodiment includes a first panel including a plurality of devices thereon and an aligning layer formed on the entire surface thereof, a second panel opposite to the first panel and including an overcoat and an aligning layer sequentially formed on the entire surface thereof, and a liquid crystal layer interposed between the first panel and the second panel. It is preferable that the liquid crystal and the overcoat satisfy the relation

$$\frac{{RC}_{lc}}{{RC}_{oc}} ≻ {10}^{3} .$$

### CROSS-REFERENCES TO RELATED APPLICATIONS

This application is a Continuation-In-Part of U.S. application Ser. No. 11/180,654, filed on Jul. 14, 2005, which is a Continuation of U.S. patent application Ser. No. 10/398,480, filed on May 22, 2003, now U.S. Pat. No. 6,927,827, which claims priority to Korean Patent Application No. 2001-47488, filed on Aug. 7, 2001, the disclosures of which are all incorporated herein in their entireties by reference.

### BACKGROUND OF THE INVENTION

(a) Field of the Invention

The present invention relates to a liquid crystal display, and in particular to a coplanar electrode (“CE”) type liquid crystal display and a manufacturing method thereof.

(b) Description of the Related Art

A coplanar electrode (“CE”) type liquid crystal display (“LCD”) includes a plurality of pixel electrodes and a plurality of common electrodes provided on one panel. The CE type LCD drives liquid crystal molecules using horizontal electric field nearly parallel to the panel between the pixel electrode and the common electrodes, thereby realizing wide viewing angle.

In the CE type LCD, a plurality of pixel areas defined by intersections of a plurality of gate lines and a plurality of data lines are formed in a matrix form on a thin film transistor (“TFT”) array panel. Each of pixel areas includes a switching element electrically connected to one of the gate lines and one of the data lines, a pixel electrode electrically connected to the switching element and a common electrode opposite each other and extending nearly parallel to the pixel electrode to form horizontal electric field.

On a color filter panel opposite to the TFT array panel, a plurality of color filters of red color R, green color G or blue color B are provided in pixel areas, and a black matrix for blocking light leakage between the pixel areas is provided and an overcoat is formed thereon.

In such an LCD, deterioration of image quality due to vertical bouncing becomes a serious problem. The vertical bouncing means that the electric field applied to a liquid crystal layer for driving the LCD is dynamically distorted around 60 Hz, which is driving frequency of the LCD, due to a certain reason, and the liquid crystal molecules are moves under the influence of the distorted electric field. This vertical bouncing appears as flicker of screen to deteriorate image quality.

### SUMMARY OF THE INVENTION

An LCD according to an embodiment of the present invention prevents poor images of an LCD.

An LCD according to an embodiment of the present invention establishes the relation of ε (permittivity)·ρ (resistivity) between a liquid crystal layer, an aligning layer or an overcoat for preventing poor images so that the bouncing dose not appear.

In detail, an LCD according to an embodiment of the present invention includes a first substrate; a plurality of pixel electrodes formed on the first substrate; a thin film transistor connected to the pixel electrodes; a plurality of common electrodes formed on the first substrate; a first alignment layer covering the pixel electrode, the thin film transistor, and the common electrode; a second substrate facing the first substrate; an overcoat formed on the second substrate; and a liquid crystal layer interposed between the first substrate and the second substrate. It is preferable that the aligning layer, the liquid crystal layer and the overcoat satisfy the relation

$$\frac{{ρɛ}_{lc + al}}{{ρɛ}_{oc}} ≻ {10}^{2} .$$

The LCD may further comprise a light blocking layer and a color filter interposed between the second substrate and the overcoat.

The pixel electrodes may extend parallel to the common electrodes and may be alternately arranged with the common electrodes.

The common electrodes may include first and second electrodes making an angle of about 15-45 degrees.

An LCD according to another embodiment of the present invention includes a first substrate; a plurality of pixel electrodes formed on the first substrate; a thin film transistor connected to the pixel electrodes; a plurality of common electrodes formed on the first substrate; a first alignment layer covering the pixel electrode, the thin film transistor, and the common electrode; a second substrate facing the first substrate; an overcoat formed on the second substrate; and a liquid crystal layer interposed between the first substrate and the second substrate. It is preferable that the liquid crystal layer and the overcoat satisfy the relation

$$\frac{{RC}_{lc}}{{RC}_{oc}} ≻ {10}^{3} .$$

### BRIEF DESCRIPTION OF THE DRAWINGS

The above and other advantages of the present invention will become more apparent by describing preferred embodiments thereof in detail with reference to the accompanying drawings in which:

FIG. 1 is a layout view of an exemplary LCD according to an embodiment of the present invention;

FIG. 2 is a sectional view of the LCD shown in FIG. 1 taken along the line II-II′;

FIG. 3 is a layout view of another exemplary LCD according to another embodiment of the present invention;

FIG. 4 is a sectional view of the LCD shown in FIG. 3 taken along the lines IV-VI′, IV′-IV″ and IV″-IV′″;

FIGS. 5 and 6 are layout views of the other exemplary LCDs;

FIG. 7 illustrates an effective capacitive dielectric region in a normal LCD;

FIG. 8 illustrate effective capacitive dielectric region in an LCD where a vertical bouncing appears;

FIG. 9 schematically illustrates a system for measuring electrical characteristics of an overcoat;

FIG. 10 is a graph illustrating the resistances of TMAH-treated overcoats as function of the treatment times;

FIG. 11 is a graph illustrating the resistances of pure-water-treated overcoat as function of treatment times;

FIG. 12 is a graph illustrating the charged voltage as function of time for respective TMAH treatment times of overcoats which did not experience UV treatment;

FIG. 13 is a graph illustrating the charged voltage as function of time for respective TMAH treatment times of UV-treated overcoats;

FIG. 14 is a graph illustrating the resistances of an overcoat before and after TMAH cleaning;

FIG. 15 is a graph illustrating the charged voltages as function of time for an overcoat before and after TMAH cleaning; and

FIG. 16 is a graph illustrating RC value of overcoats as function of TMAH treatment time.

### DETAILED DESCRIPTION OF PREFERRED EMBODIMENTS

Now, the present invention will be described in detail with reference to the accompanying drawings.

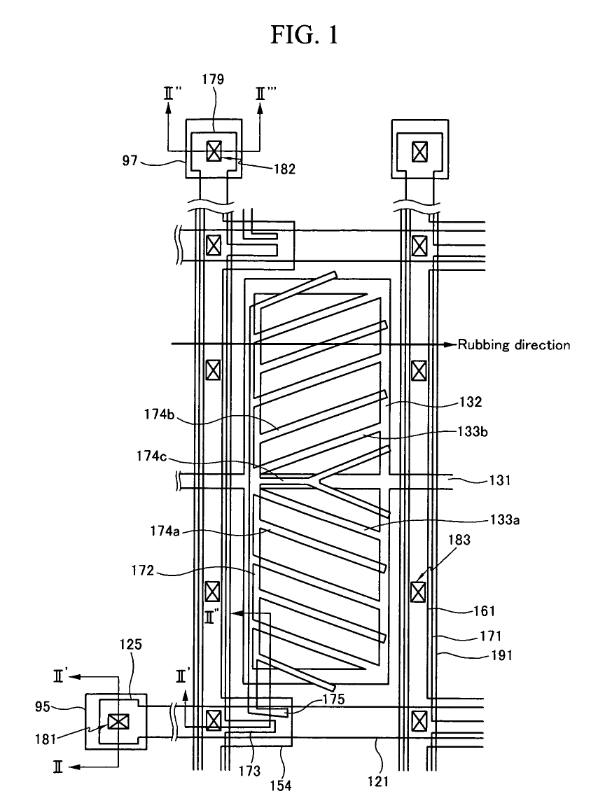

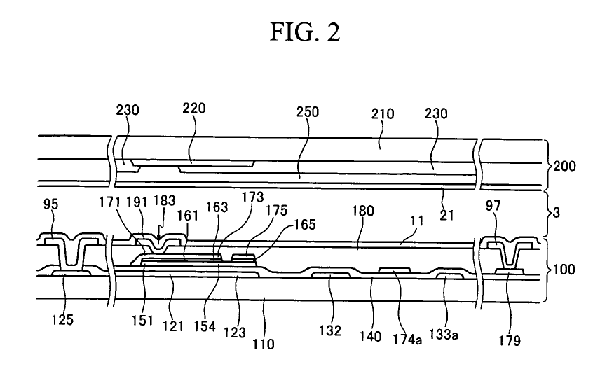

FIG. 1 is a layout view of an exemplary LCD according to an embodiment of the present invention, and FIG. 2 is a sectional view of the LCD shown in FIG. 1 taken along the lines II-II′, II′-II″, and II″-II′″.

An exemplary LCD according to an embodiment of the present invention includes a thin film transistor array panel 100, a color filter array panel 200, and a liquid crystal layer 3 interposed between the thin film transistor array panel 100 and the color filter array panel 200.

Now, the thin film transistor array panel 100 will be described in detail.

A plurality of gate lines 121 for transmitting gate signals and a plurality of common electrode lines 131 for transmitting a common voltage are formed on an insulating substrate 110.

Each gate line 121 extends substantially in a transverse direction and a plurality of portions of each gate line 121 form a plurality of gate electrodes 123.

Each common electrode line 131 extends substantially in the transverse direction and includes a plurality of sets of branches, and each set of branches include a frame 132 and a plurality of common electrodes 133a and 133b connected to the frame 132. The frame 132 has a rectangular shape including four edges. The common electrodes 133a and 133b obliquely extend and the common electrodes 133a extend from a left edge of the frame 132 in an upper right direction while the common electrodes 133b extend from the left edge of the frame 132 in a lower right direction. The extensions of the common electrodes 133a and 133b meet the gate lines 121 at an angle of about 15±8 degrees, i.e., in a range of about 7 to 23 degrees and thus they meet each other at an angle in a range of about 14 to 46 degrees, preferably in a range of about 15 to 45 degrees.

The gate lines 121 and the common electrode lines 131 may include two films having different physical characteristics, a lower film (not shown) and an upper film (not shown). The upper film is preferably made of low resistivity metal including Al containing metal such as Al and Al alloy for reducing signal delay or voltage drop in the gate lines 121 and the common electrode lines 131. On the other hand, the lower film is preferably made of material such as Cr, Mo and Mo alloy, which has good contact characteristics with other materials such as indium tin oxide (ITO) or indium zinc oxide (IZO). A good exemplary combination of the lower film material and the upper film material is Cr and Al—Nd alloy.

In addition, the lateral sides of the gate lines 121 and the common electrode lines 131 are tapered, and the inclination angle of the lateral sides with respect to a surface of the substrate 110 ranges about 30-80 degrees.

A gate insulating layer 140 preferably made of silicon nitride (SiNx) is formed on the gate lines 121 and the common electrode lines 131.

A plurality of semiconductor stripes 151 preferably made of hydrogenated amorphous silicon (abbreviated to “a-Si”) or polysilicon are formed on the gate insulating layer 140. Each semiconductor stripe 151 extends substantially in a longitudinal direction and has a plurality of projections 154 branched out toward the gate electrodes 123.

A plurality of ohmic contact stripes and islands 161 and 165 preferably made of silicide or n+ hydrogenated a-Si heavily doped with n type impurity are formed on the semiconductor stripes 151. Each ohmic contact stripe 161 has a plurality of projections 163, and the projections 163 and the ohmic contact islands 165 are located in pairs on the projections 154 of the semiconductor stripes 151.

The lateral sides of the semiconductor stripes 151 and the ohmic contacts 161 and 165 are tapered, and the inclination angles thereof are preferably in a range between about 30-80 degrees. A plurality of data lines 171 and a plurality of pixel electrode lines 172 separated from each other are formed on the ohmic contacts 161 and 165 and the gate insulating layer 140.

The data lines 171 for transmitting data voltages extend substantially in the longitudinal direction and intersect the gate lines 121 and the common electrode lines 131. Each pixel electrode lines 172 extend substantially in the longitudinal direction and includes a plurality of branches 174a-174c called pixel electrodes. The pixel electrodes 174a and 174b extend parallel to the common electrodes 133a and 133b respectively, and the pixel electrode 174c extends along the common electrode line 131 and is bifurcated into two branches parallel to the common electrodes 133a and 133b, respectively.

Each data line 171 includes a plurality of branches of each data line 171 projecting toward the gate lines 121 to form a plurality of source electrodes 173, and each pixel electrode line 172 further includes an extension 175 projecting toward the source electrode 173 forming a drain electrode 175. Each pair of the source electrodes 173 and the drain electrodes 175 are opposite each other with respect to a gate electrode 123. A gate electrode 123, a source electrode 173, and a drain electrode 175 along with a projection 154 of a semiconductor stripe 151 form a TFT having a channel formed in the projection 154 disposed between the source electrode 173 and the drain electrode 175.

The pixel electrodes 174a-174c receive the data voltages from the drain electrodes 175 and generate electric fields in cooperation with the common electrodes 133a and 133b, which reorient liquid crystal molecules in the liquid crystal layer disposed therebetween. The pixel electrodes 174a-174c and the common electrodes 133a and 133b form a liquid crystal capacitor, which stores applied voltages after turn-off of the TFT. An additional capacitor called a “storage capacitor,” which is connected in parallel to the liquid crystal capacitor, is provided for enhancing the voltage storing capacity. The storage capacitors are implemented by overlapping the pixel electrode lines 172 with the frames 132 of the common electrode lines 131.

The data lines 171 and the pixel electrode lines 172 may also include a lower film (not shown) preferably made of Mo, Mo alloy or Cr and an upper film (not shown) located thereon and preferably made of Al containing metal.

Like the gate lines 121 and the common electrode lines 131, the data lines 171 and the pixel electrode lines 172 have tapered lateral sides, and the inclination angles thereof range about 30-80 degrees.

The ohmic contacts 161 and 165 are interposed only between the underlying semiconductor stripes 151 and the overlying data lines 171 and the overlying drain electrodes 175 thereon and reduce the contact resistance therebetween. The semiconductor stripes 151 include a plurality of exposed portions, which are not covered with the data lines 171 and the drain electrodes 175, such as portions located between the source electrodes 173 and the drain electrodes 175. Although the semiconductor stripes 151 are narrower than the data lines 171 at most places, the width of the semiconductor stripes 151 becomes large near the gate lines 121 as described above, to enhance the insulation between the gate lines 121 and the data lines 171.

A passivation layer 180 is formed on the data lines 171 and the pixel electrode lines 172, and the exposed portions of the semiconductor stripes 151. The passivation layer 180 is preferably made of photosensitive organic material having a good flatness characteristic, low dielectric insulating material such as a-Si:C:O and a-Si:O:F formed by plasma enhanced chemical vapor deposition (PECVD), or inorganic material such as silicon nitride.

The passivation layer 180 has a plurality of contact holes 182 and 183 exposing end portions 179 of the data lines 171 and mid-portions of the data lines 171, respectively. The passivation layer 180 and the gate insulating layer 140 have a plurality of contact holes 181 exposing end portions 125 of the gate lines 121. The contact holes 181-183 can have various shapes such as polygon or circle. The area of each contact hole 181 or 182 is preferably equal to or larger than 0.5 mm×15 μm and not larger than 2 mm×60 μm.

A plurality of redundant data lines 191 and a plurality of contact assistants 95 and 97, which are preferably made of ITO, IZO or Cr, are formed on the passivation layer 180.

The redundant data lines 191 are connected to the data lines 171 through the contact holes 183 to form compensatory signal paths of the data voltages. The contact assistants 95 and 97 are connected to the exposed end portions 125 of the gate lines 121 and the exposed end portions 179 of the data lines 171 through the contact holes 181 and 182, respectively. The contact assistants 95 and 97 are not requisites but preferred to protect the exposed portions 125 and 179 and to complement the adhesiveness of the exposed portion 125 and 179 and external devices.

Finally, an alignment layer 11 made of such as polyimide is formed on the redundant data lines 191, the contact assistants 95 and 97, and the passivation layer 180. The alignment layer 11 is rubbed in a direction indicated by an arrow as shown in FIG. 1, which is substantially parallel to the gate lines 121.

Next, the color filter array panel 200 will be described in detail.

A light blocking layer 220 is formed on an insulating substrate 210. A plurality of color filters 230 are formed on the light blocking layer 220. A overcoat 250 is formed on the color filters 230. A alignment layer 21 made of such as polyimide is formed on the overcoat 250.

Here, the aligning layers 11 and 21, the liquid crystal layer 3 and the overcoat 250 satisfy

$$\frac{{ρɛ}_{lc + al}}{{ρɛ}_{oc}} ≻ {10}^{2} ,$$

or the liquid crystal layer 3 and the overcoat 250 satisfy

$$\frac{{RC}_{lc}}{{RC}_{oc}} ≻ {10}^{3} .$$

“ρ” represents resistivity and “ε” represents dielectric permittivity

When the aligning layers 11 and 21, the liquid crystal layer 3 and the overcoat 250 satisfy one of the two conditions, the bouncing generated in an LCD can be decreased or eliminated.

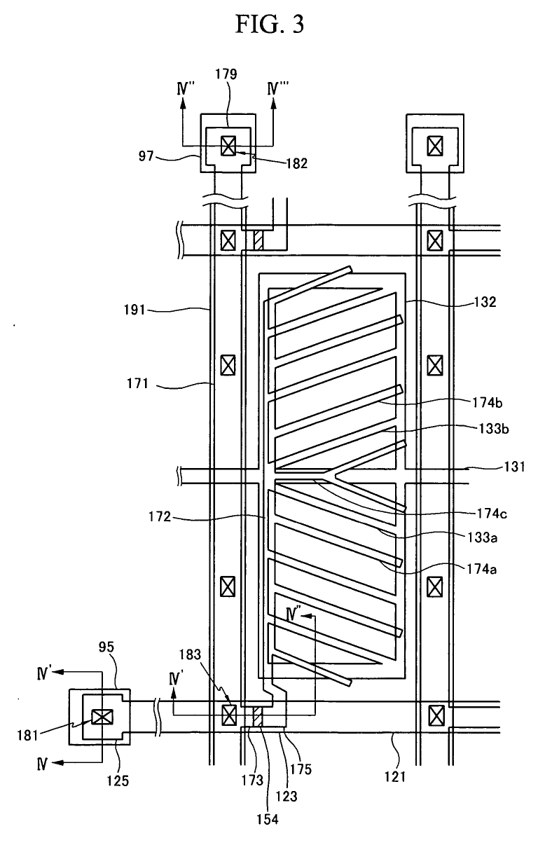

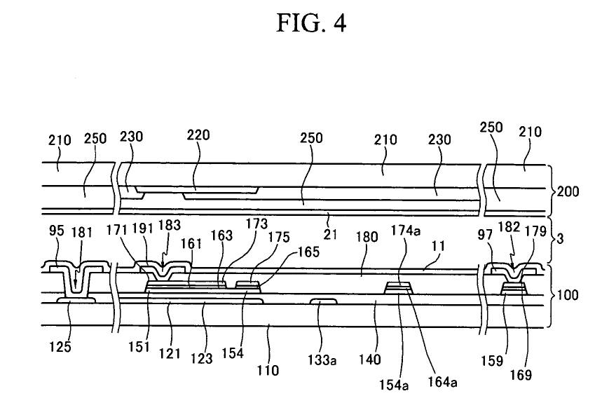

FIG. 3 is a layout view of an exemplary LCD according to another embodiment of the present invention, and FIG. 4 is a sectional view of the LCD shown in FIG. 3 taken along the lines IV-VI′, IV′-IV″ and IV″-IV′″.

As shown in FIGS. 3 and 4, a layered structure of an LCD according to this embodiment is almost the same as that shown in FIGS. 1 and 2. That is, a plurality of gate lines 121 including a plurality of gate electrodes 123 and a plurality of common electrodes lines 131 including a plurality of common electrodes 133a and 133b are formed on a substrate 110, and a gate insulating layer 140, a plurality of semiconductor stripes 151 including a plurality of projections 154, and a plurality of ohmic contact stripes 161 including a plurality of projections 163 and a plurality of ohmic contact islands 165 are sequentially formed thereon. A plurality of data lines 171 including a plurality of source electrodes 173 and a plurality of pixel electrode lines 172 including a plurality of drain electrodes 175 and a plurality of pixel electrodes 174a-174c are formed on the ohmic contacts 161 and 165, and a passivation layer 180 is formed thereon. A plurality of contact holes 181, 182 and 183 are provided at the passivation layer 180 and/or the gate insulating layer 140, and a plurality of redundant data lines 191 and a plurality of contact assistants 95 and 97 are formed on the passivation layer 180.

Different from the LCD shown in FIGS. 1 and 2, the LCD according to this embodiment further extends the extensions 154 of the semiconductor stripes 151 and the ohmic contact islands 165 along the pixel electrode lines 172 and the pixel electrodes 174a-174c. Reference numerals 154a and 164a indicate extensions of the extensions 154 of the semiconductor stripes 154 and of the ohmic contact islands 165 located under the pixel electrode 174a.

The semiconductor stripes and islands 151 have almost the same planar shapes as the data lines 171 and the pixel electrode lines 172 as well as the underlying ohmic contacts 161 and 165, except for portions of the projections 154 where TFTs are provided. The semiconductor stripes 151 include some exposed portions, which are not covered with the data lines 171 and the pixel electrode lines 172, such as portions located between the source electrodes 173 and the drain electrodes 175.

Here, the aligning layers 11 and 21, the liquid crystal layer 3 and the overcoat 250 satisfy

$$\frac{{ρɛ}_{lc + al}}{{ρɛ}_{oc}} ≻ {10}^{2} ,$$

or the liquid crystal layer 3 and the overcoat 250 satisfy

$$\frac{{RC}_{lc}}{{RC}_{oc}} ≻ {10}^{3} .$$

“ρ” represents resistivity and “ε” represents dielectric permittivity

When the aligning layers 11 and 21, the liquid crystal layer 3 and the overcoat 250 satisfy one of the two conditions, the bouncing generated in an LCD can be decreased or eliminated.

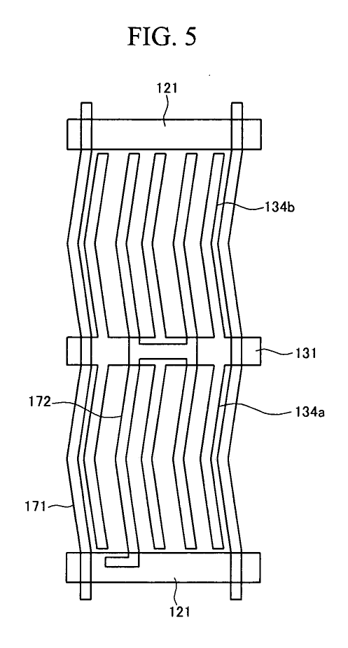

FIG. 5 is a layout view of another exemplary LCD.

The embodiment of FIG. 5 has common electrodes and pixel electrodes having different planar shape from that of the embodiment of FIGS. 1 to 4.

In FIG. 5, the pixel electrode 172 and the common electrodes 134a and 134b are overall extended in a direction parallel to data lines 171 and are bent twice in a pixel area. The bent portions are disposed at upper half and lower half of the pixel area. The data lines 171 are also bent in the same tendency as the common electrodes 134a and 134b.

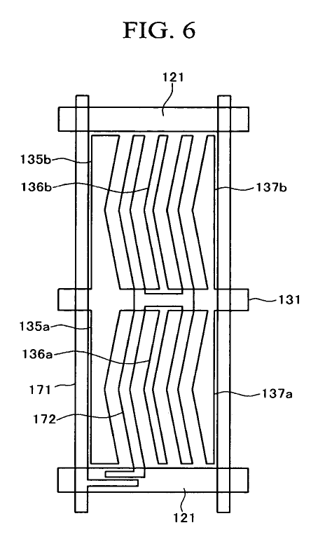

FIG. 6 is a layout view of another exemplary LCD.

The embodiment of FIG. 6 has common electrodes and pixel electrodes having different planar shape from that of the embodiment of FIGS. 1 to 4.

In FIG. 6, the pixel electrode 172 and the center common electrodes 136a and 136b are overall extended in a direction parallel to data lines 171 and are bent twice in a pixel area. The bent portions are disposed at upper half and lower half of the pixel area. Left common electrodes 135a and 135b and right common electrodes 137a and 137b have straight sides adjacent to the data lines 171 and bent sides adjacent to the pixel electrodes 172. The bent sides are bent along the pixel electrodes 172. The data lines 171 are straight lines.

Here, the aligning layers 11 and 21, the liquid crystal layer 3 and the overcoat 250 satisfy

$$\frac{{ρɛ}_{lc + al}}{{ρɛ}_{oc}} ≻ {10}^{2} ,$$

or the liquid crystal layer 3 and the overcoat 250 satisfy

$$\frac{{RC}_{lc}}{{RC}_{oc}} ≻ {10}^{3} .$$

“ρ” represents resistivity and “ε” represents dielectric permittivity

Now, it will be described that when the two conditions are satisfied, why the bouncing generated in an LCD can be decreased or eliminated.

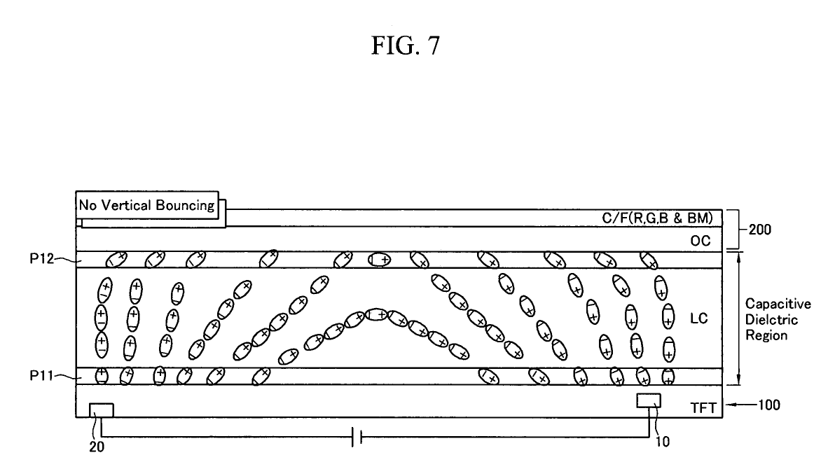

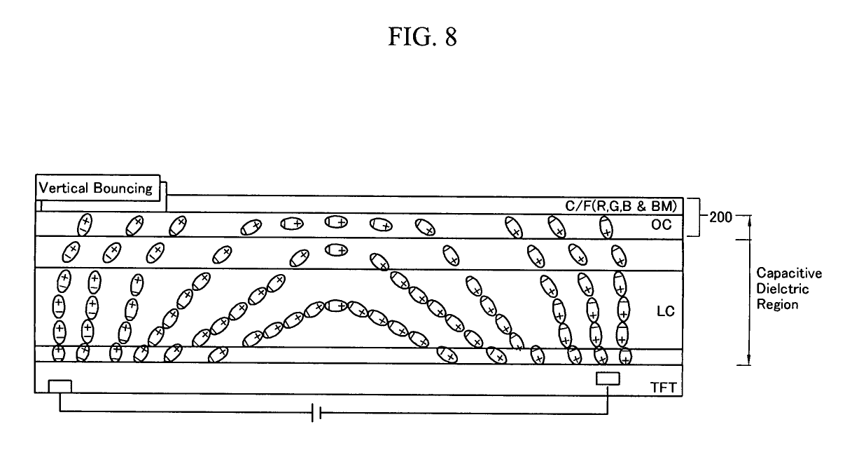

FIGS. 7 and 8 schematically illustrate LCDs. FIG. 7 illustrates an effective capacitive dielectric region in a normal LCD and FIG. 8 illustrates an effective capacitive dielectric region in an LCD where bouncing appears.

As described above, in a CE type LCD, a liquid crystal layer LC is disposed between a TFT array panel 100 including a pixel electrode 10 and a common electrode 20 opposite thereto and a color filter panel including a color filter CF and an overcoat OC. A first and a second aligning layer PI1 and PI2 for determining the alignment of the liquid crystal are coated on the TFT array panel 100 and the color filter panel 200.

Since the pixel electrode 10 and the common electrode 20 are formed on the same panel, the electric field generated therebetween forms an oval curve with respect to the panel 100, and this aligns the liquid crystal molecules as shown in FIGS. 7 and 8.

As shown in FIG. 7, a effective capacitive dielectric region of a normal LCD is a region between the first aligning layer PI1 and the second aligning layer PI2 including the liquid crystal layer LC. The overcoat OC does not play a part of a capacitive dielectric for electric field applied to the LCD.

Examples of main materials forming the overcoat of an LCD are an acryl-based resin and an epoxy resin, a curing agent. These materials have resistance ranging several kΩ to hundreds of kΩ, which may not work as an organic insulating layer sufficiently. Thus, the surface of the overcoat is filled with charges by the electric field applied to the LCD so that the electric field cannot penetrate into the inside of the overcoat. The overcoat does not work as a dielectric of capacitor.

In the meantime, the resistance of the overcoat increases through wet processes such as alkali cleaning or ultra pure water cleaning. The increased resistance increases the charging time of charges onto the surface of the overcoat due to the electric field applied to the LCD, thereby making the overcoat work as a capacitive dielectric for a moment. In addition, the dielectric constant of a dielectric is changed to vary the capacitance during the charging. This variation of capacitance induces the variation of the liquid crystal alignment to cause bouncing appearing as a screen flickering

In detail, a ultra-violet (“UV”) treatment decomposes organic material of the surface of the overcoat to generate impurity such as acids. The penetration of organic adsorbent such as tetramethylammonium hydroxide (“TMAH”) or water used for the process of forming the aligning layers changes electrical characteristics of the overcoat, thereby distorting the electric field applied to the LCD.

In other words, after forming the overcoat, the impurities are penetrated into polymers composing the unstable overcoat during the cleaning process. As a result, the charge carrier mobility of the overcoat is decreased and the resistance of the overcoat is increased so that the overcoat also works as capacitive dielectric together with the liquid crystal.

Considering this effect, the effective capacitive dielectric region of a liquid crystal capacitor in the LCD, as shown in FIG. 8, becomes a region between the first aligning layer PI1 and the second aligning layer PI2 including the liquid crystal layer LC as well as the overcoat OC. As a result, the electric field applied to the LCD is distorted, and flicker appears until the distorted field is stabilized.

Now, the relation between the variation of the resistance of an overcoat and the charging ratio of the field is described with reference to an experiment.

First, the variation of the resistance of an overcoat and the variation of a capacitance was measured using TMAH and pure water.

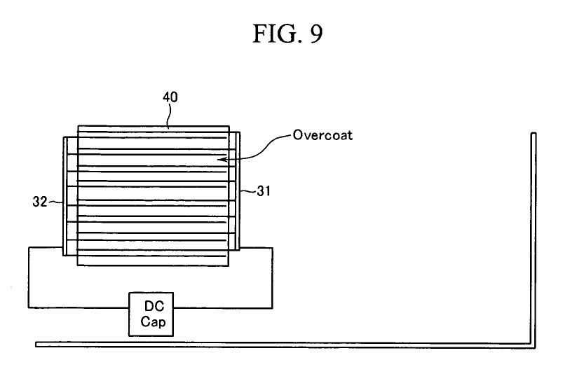

The experimental condition prepared for measurement is shown in FIG. 9.

FIG. 9 schematically illustrates a structure of a panel for the measurement of the electrical characteristics of an overcoat.

A pair of electrodes 31 and 32 for the measurement of the electrical characteristic was formed by depositing and patterning a Cr/Al alloy layer with 2,500 Å thickness. The length of the electrodes 31 and 32 was 33.8 cm, and the distance between the electrodes 31 and 32 was 10.28 μm.

After forming an overcoat 40 on the above described electrodes 31 and 31, the surface of the overcoat was not treated or was treated by UV and ozone depending on the experimental condition. Thereafter, the overcoat 40 was wetted in TMAH solution or pure water at respective times, and then, the resistance R and the capacitance C of the overcoat 40 were measured.

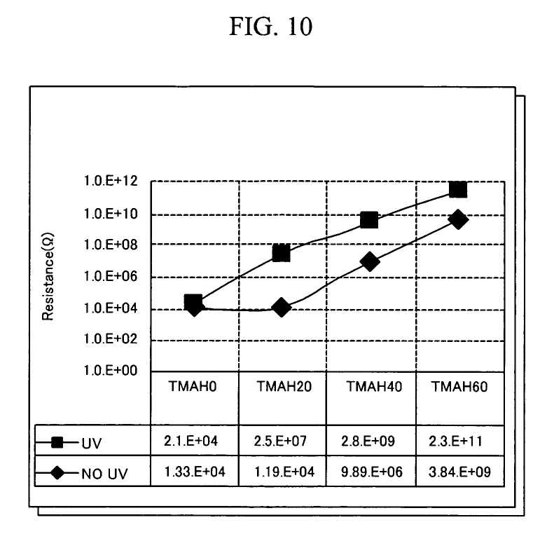

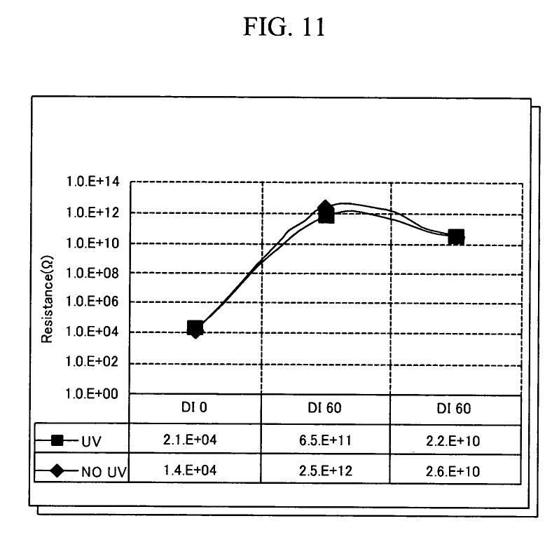

FIG. 10 is a graph illustrating the resistances of TMAH-treated overcoats as function of treatment times, and FIG. 11 is a graph illustrating the resistances of pure-water-treated overcoats as function of treatment times.

Among the pure-water-wetted overcoats, there was no difference in the resistances of the UV-treated overcoats and the overcoats that did not experience UV treatment. In contrast, among the TMAH-wetted overcoats, the resistances of the UV-treated overcoats were larger than those of the overcoats which did not experience UV treatment.

When an organic film is subject to UV treatment, its surface is deformed. The UV treatment results in the release of fatty carbonic bonds, and ozone or oxygen is chemically adsorbed in the released bond. As a result, the surface of the overcoat has a hydrophility.

Then, when cleaning the overcoat using TMAH, ion impurity is physically and chemically adsorbed on the surface of the overcoat, thereby decreasing the mobility of the electrical charge carriers and increasing the resistance of the overcoat.

Accordingly, the UV-treated and TMAH-cleaned overcoats show drastically different resistances as shown in FIG. 10.

Table 1 illustrates the measured resistances R and the measured capacitances C of overcoats under the respective conditions in order to examine the effect of TMAH treatment depending on UV treatment.

TABLE 1

| TMAH | | | | | | |
|---|---|---|---|---|---|---|
| Treatment | | | C (pF) | | | |
| Time | R (Ω) | | No | | RC Delay | |
| (minutes) | No UV | UV | UV | UV | No UV | UV |
| 0 | 1.33E+04 | 2.1E+04 | 100.0 | 123.5 | 1.33E+06 | 2.59E+06 |
| 20 | 1.19E+04 | 2.5E+07 | 223.5 | 2.7 | 2.66E+06 | 6.75E+07 |
| 40 | 9.89E+06 | 2.8E+09 | 13.0 | 44.0 | 1.29E+04 | 1.23E+11 |
| 60 | 3.84E+09 | 2.3E+11 | 74.7 | 74.7 | 2.87E+11 | 3.91E+12 |

The resistances of the UV-treated overcoats are larger than those of the overcoats which did not experience UV treatment. Furthermore, the overcoats with longer TMAH time had larger resistances regardless of UV treatment.

Meanwhile, the increase of the resistance of the overcoat works as main factor of RC delay for the field applied to the liquid crystal layer.

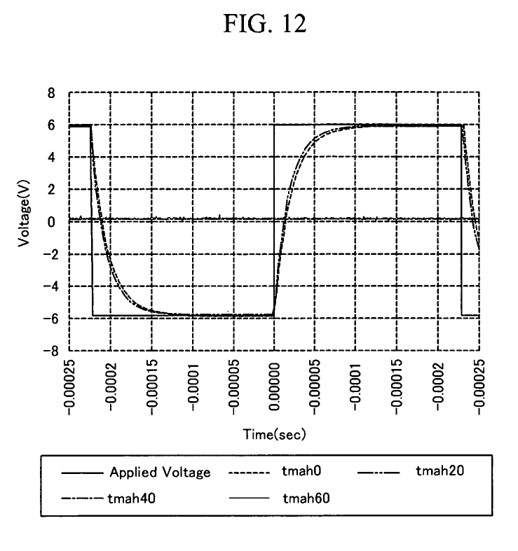

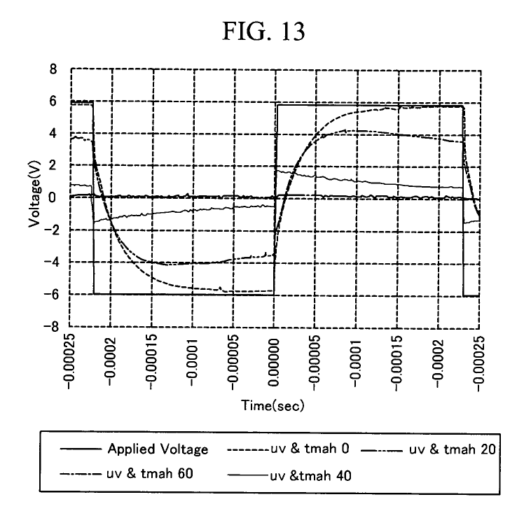

FIG. 12 is a graph illustrating the charged voltage as function of time for respective TMAH treatment times of overcoats which did not experience UV treatment, and FIG. 13 is a graph illustrating the charged voltage as function of time for respective TMAH treatment times of UV-treated overcoats.

The charging times to an expected voltage for the overcoats which did not experience UV treatment were relatively short.

However, an expected voltage for the UV-treated overcoats was obtained after relatively long times elapsed. This is the case as the TMAH treatment time becomes longer. Like this, a stable voltage for a TMAH-treated overcoat is expected to be obtained after a predetermined time elapses. This indicates the same result as the Table 1.

To verify this result, the resistances and the charged voltages before and after TMAH cleaning, which is performed prior to formation of aligning layers, were measured.

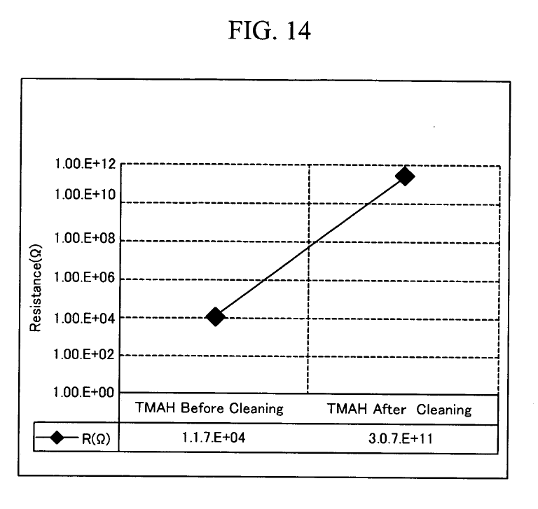

FIG. 14 is a graph illustrating the resistances of an overcoat before and after TMAH cleaning.

As expected, the resistance of the overcoat after the TMAH cleaning is increased.

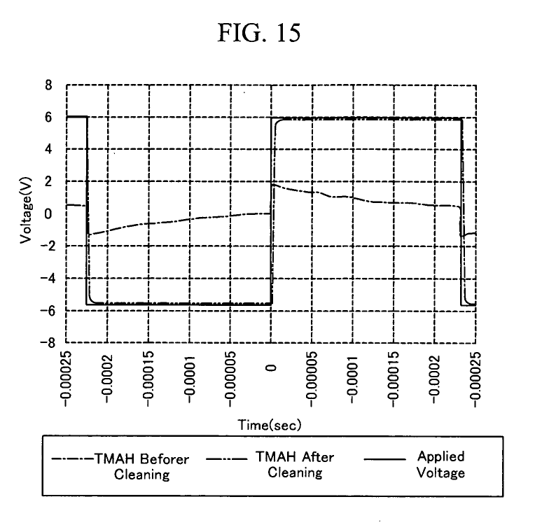

FIG. 15 is a graph illustrating the charged voltages as function of time for an overcoat before and after TMAH cleaning.

The charged voltage before the TMAH cleaning of the overcoat was almost the same as an applied voltage, while the charged voltage after the TMAH cleaning of the overcoat was very different from the applied voltage. It can be seen that this results from the increase of the resistance of the overcoat after the TMAH cleaning.

To review the results, it can be certified again that the physical and chemical characteristics of the surface of the overcoat are changed by TMAH treatment, thereby decreasing the mobility of the electrical charge carriers and increasing the resistance, thereby decreasing the charging ratio.

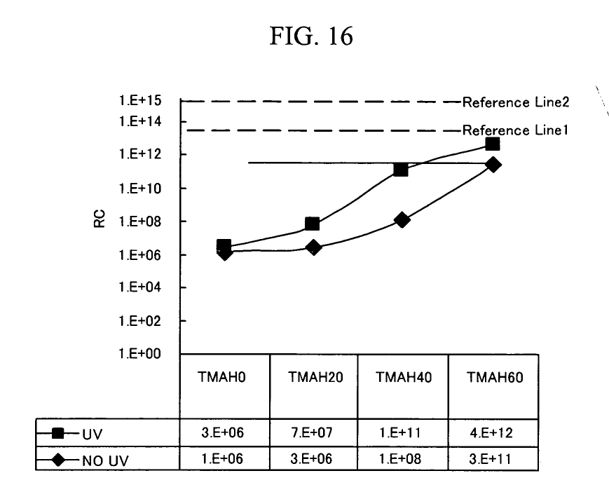

FIG. 16 is a schematic graph illustrating RC value of overcoats as function of TMAH treatment time shown in Table 1. In this graph, a reference line 1 refers to an RC value of a liquid crystal layer and an aligning layer and a reference line 2 refers to an RC value of a liquid crystal layer.

A panel with a liquid crystal layer and an aligning layer similar to the panel shown in FIG. 9 for measuring the electrical characteristics of an overcoat was obtained by forming the liquid crystal layer and the aligning layer in sequence instead of forming the overcoat. The RC value of the liquid crystal layer and the aligning layer indicated by the reference line 1 was then obtained by measuring R values and C values of the liquid crystal layer and the aligning layer. In addition, the RC value of a liquid crystal layer is obtained by the same manner.

The bouncing appeared in case that a UV-treated overcoat was TMAH-treated for 40 minutes or longer, and in case that an overcoat that was not UV-treated was TMAH-treated for 60 minutes or longer. It can be seen that the bouncing in the LCD of the present experiment appears when the RC value of the overcoat is 1.0E12 (referred to as one dotted line in the figure).

Considering the bouncing appears due to the variation of the capacitive dielectric constants of a liquid crystal capacitor as described above, it is required to establish the relation of RC value of an overcoat and RC value of a liquid crystal layer or an aligning layer.

Referring to the graph shown in FIG. 16, it can be inferred that the bouncing appears in the following case:

$$\frac{{RC}_{lc + al}}{{RC}_{oc}} ≺ {10}^{2} , \qquad ( 1 )$$

where “lc”, “al” and “oc” are abbreviations of liquid crystal layer, aligning layer and overcoat, respectively.

Therefore, the relation for preventing the bouncing in an LCD is:

$$\frac{{RC}_{lc + al}}{{RC}_{oc}} ≺ {10}^{2} . \\ Since \\ R = ρ \frac{L}{A} , and \\ C = ɛ \frac{A}{d} , \\ R \times C = ρ \frac{L}{A} \times ɛ \frac{A}{d} = ρɛ . \qquad ( 2 )$$

Here, ρ is resistivity, L is length, A is area, ε is dielectric constant, and d is distance.

Accordingly, an overcoat, a liquid crystal layer and an aligning layer of an LCD according to an embodiment of the present invention satisfy the following relation:

$$\frac{{ρɛ}_{lc + al}}{{ρɛ}_{oc}} ≻ {10}^{2} . \qquad ( 3 )$$

Furthermore, referring to the graph shown in FIG. 16, it can be seen that the bouncing appears in the following case:

$$\frac{{RC}_{lc}}{{RC}_{oc}} ≺ {10}^{3} . \qquad ( 4 )$$

Therefore, the relation for preventing the bouncing in an LCD is:

$$\frac{{RC}_{lc}}{{RC}_{oc}} ≻ {10}^{3} . \qquad ( 5 )$$

As a result, it is preferable that the materials satisfy the following relation:

$$\frac{{ρɛ}_{lc}}{{ρɛ}_{oc}} ≻ {10}^{3} . \qquad ( 6 )$$

Referring to the above described relationship, the bouncing can be improved by decreasing ρε of an overcoat or by increasing ρε of a liquid crystal layer or an aligning layer.

Table 2 illustrates the bouncing depending on the value of ρ of a liquid crystal layer used in an LCD.

TABLE 2

| No UV treatment | Bouncing |
|---|---|
| 1.0E+12 | Strong |
| 1.9E+13 | ↑ |
| 3.3E+13 | ↑ |
| 1.0E+14 | Weak |

As a result of evaluation of the bouncing in an LCD depending on p of a liquid crystal layer, the bouncing disappeared as p of the liquid crystal layer becomes larger. This is the data verifying the relations (3) and (4).

As described above, the present invention provides a relation of ε (dielectric permittivity)·ρ (resistivity) among a liquid crystal layer, an aligning layer or an overcoat for preventing poor image quality such as bouncing in an LCD.

An LCD according to an embodiment of the present invention, has a structure with a first panel including a plurality of devices provided thereon and an aligning layer formed on the entire surface thereof, a second panel located opposite the first panel and including an overcoat and an aligning layer formed in sequence on the entire surface, and a liquid crystal layer interposed between the first panel and the second panel. The aligning layer, the liquid crystal layer and the overcoat satisfy

$$\frac{{ρɛ}_{lc + al}}{{ρɛ}_{oc}} ≻ {10}^{2} ,$$

or the liquid crystal layer and the overcoat satisfy

$$\frac{{RC}_{lc}}{{RC}_{oc}} ≻ {10}^{3} .$$

In this way, the bouncing generated in an LCD can be decreased or eliminated.

As described above, according to the present invention, it is possible to prevent a poor image such as bouncing generated in an LCD by adjusting ρ or ε of an overcoat, a liquid crystal layer or an aligning layer used for the LCD.

Although the illustrative embodiments have been described herein with reference to the accompanying drawings, it is to be understood that the present invention is not limited to those precise embodiments, and that various other changes and modifications may be affected therein by one of ordinary skill in the related art without departing from the scope or spirit of the invention. All such changes and modifications are intended to be included within the scope of the invention as defined by the appended claims.

What is claimed is:

1. A liquid crystal display comprising:
a first substrate;
a plurality of pixel electrodes formed on the first substrate;
a thin film transistor connected to the pixel electrodes;
a plurality of common electrodes formed on the first substrate;
a first alignment layer covering the pixel electrode, the thin film transistor, and the common electrode;
a second substrate facing the first substrate;
an overcoat formed on the second substrate;
a liquid crystal layer interposed between the first substrate and the second substrate,
wherein the aligning layer, the liquid crystal layer, and the overcoat satisfy a relation
$$\frac{{ρɛ}_{lc + al}}{{ρɛ}_{oc}} ≻ {10}^{2} .$$

2. The liquid crystal display of claim 1, further comprising a light blocking layer and a color filter interposed between the second substrate and the overcoat.

3. The liquid crystal display of claim 1, wherein the pixel electrodes extend parallel to the common electrodes.

4. The liquid crystal display of claim 3, wherein the pixel electrodes are alternately arranged with the common electrodes.

5. The liquid crystal display of claim 4, wherein the common electrodes include first and second electrodes making an angle of about 15-45 degrees.

6. A liquid crystal display comprising:
a first substrate;
a plurality of pixel electrodes formed on the first substrate;
a thin film transistor connected to the pixel electrodes;
a plurality of common electrodes formed on the first substrate;
a first alignment layer covering the pixel electrode, the thin film transistor, and the common electrode;
a second substrate facing the first substrate;
an overcoat formed on the second substrate; and
a liquid crystal layer interposed between the first substrate and the second substrate,
wherein the liquid crystal layer and the overcoat satisfy a relation
$$\frac{{RC}_{lc}}{{RC}_{oc}} ≻ {10}^{3} .$$

7. The liquid crystal display of claim 6, further comprising a light blocking layer and a color filter interposed between the second substrate and the overcoat.

8. The liquid crystal display of claim 6, wherein the pixel electrodes extend parallel to the common electrodes.

9. The liquid crystal display of claim 8, wherein the pixel electrodes are alternately arranged with the common electrodes.

10. The liquid crystal display of claim 9, wherein the common electrodes include first and second electrodes making an angle of about 15-45 degrees.
